(19) United States
(12) Patent Application Publication
(10) Pub. No.: US 2021/0057839 A1
(43) Pub. Date: Feb. 25, 2021

(54) ADAPTIVE MULTI-PURPOSE PNEUMATIC ELECTRIC CONNECTOR

(71) Applicant: IDEAL Industries, Inc., Sycamore, IL (US)

(72) Inventors: Joshua W. Haney, Fitchburg, MA (US); Christine M. Svelnis, Boylston, MA (US); Calvin M. Downey, Buckfield, ME (US)

(21) Appl. No.: 16/958,298

(22) PCT Filed: Feb. 15, 2019
(86) PCT No.: PCT/US19/18247

§ 371 Date: Jun. 26, 2020

Related U.S. Application Data
(60) Provisional application No. 62/631,099, filed on Feb. 15, 2018.

(51) Int. Cl. H01R 13/00; H01R 13/52; B23K 9/32

(52) U.S. Cl. CPC H01R 13/005; B23K 9/122; B23K 9/323; H01R 13/5219

(57) ABSTRACT

An adaptable multiple purpose connector system for simultaneous pneumatic and electric connections includes a pin and socket. Each connector has an electrical contact a cylindrical hollow core extending through the connector from one end to other. The pin and socket are shaped to be complementary to each other such that the pin can be at least partially inserted into the socket such that the cylindrical hollow cores are aligned and the electrical contact are mated. An internal seal forms an air-tight connection is formed between the pin and socket connector. An external seal positioned on the outward ends of the pin and socket connectors creates a sealed pneumatic connection with pneumatic tubes when the connectors are mated. Additional connections may include solid transport such as feed wire in an example welding configuration.

### RELATED APPLICATION INFORMATION

This application claims the benefit of and is a continuation of U.S. Provisional Application No. 62/631,099 filed Feb. 15, 2018, which is incorporated by reference in its entirety.

### FIELD OF THE DISCLOSURE

The present disclosure relates generally to a connector for a welding adaptor and more particularly to an adaptive multi-process pneumatic electric connector.

### BACKGROUND OF RELATED ART

Current welding setups require the user to swap entire cable assemblies—i.e., a welding gun and cables—to use different types of welding methods on a multi-process welding machine. For instance, different welding processes require the transfer of up to four different things through the cable assembly to the front end of the welding gun, namely: (1) power; (2) signal; (3) gas; and (4) metal wire.

As illustrated in FIG. 1, currently, gas and wire are fed through a cable, while power is connected to the gun with two threaded pieces. Meanwhile, signal is pulled away from the cable and connected with a separate connection. This is not ideal for a user who wants to use their multi-process welding machine for multiple processes. The cable assemblies currently disconnect at the welding machine itself, which can be seen in FIG. 1B, while the welder connection can be seen below.

U.S. Pat. No. 5,338,917 describes an ergonomically designed welding gun with a quick disconnect cable assembly. With the noted welding gun and cable assembly, the conductor tube can be rotated 360° about the centerline of the handle, the conductor tube can be articulated 15° up or down, the rear portion of the handle includes a gentle curve of approximately 10° off the centerline.

U.S. Pat. No. 5,258,599 describes convertible TIG, MIG or plasma arc welding system, comprising a cylindrical docking body mountable in a socket at a welding station having utilities passages therethrough for receiving an elongated metal electrode, shielding and plasma gases, welding potential and cooling water. The electrode passage is threaded at one end to interchangeably mount any of a plurality of electrode feed assemblies for consumable wire or tungsten electrodes and an output fixture is mounted at the other end of the body to receive the electrode and the plasma or shielding gas and pass them from the body. A nozzle assembly is removably mountable on the other end of the docking body in surrounding relationship with the output fixture and the associated tip assembly and communicates with the shielding gas passage for passing shielding gas to the working end of the nozzle. The docking body has internal channels among the passages so as to circulate cooling water through both the output fixture and the nozzle assembly. The working end of the nozzle assembly interchangeably mounts any of a plurality of gas directing assemblies for directing gases relative to the arc. The system can be converted among TIG, MIG and plasma arc welding by simply changing the electrode feed assembly, the tip assembly and the gas directing assembly. Alternatively, the entire nozzle assembly can be replaced with one designed for TIG or MIG welding.

US Patent Publication No. US 2017/0151622 describes an adapter assembly including a coupling portion that couples to a gas metal arc welding (GMAW) wire drive assembly and receives electrical current flow from the GMAW wire drive assembly. The adapter assembly includes a receiving portion that couples with a connector of a welding cable of a non-GMAW torch to provide the electrical current flow to the non-GMAW torch from the GMAW wire drive assembly. Further, the adapter assembly includes an insulating component that affixes around the receiving portion.

Australian Patent No. AU 2011100104 A4 describes a hybrid welding torch involving the installation of a MIG welding torch plug onto a TIG welding torch and cable (assembly) in order that the TIG welding torch may be plugged into a welder and obtain benefit of having electrical power, shielding gas and switched signal provided to it via the existing MIG socket on a multifunction (Constant Voltage and or Constant Current) welder for the purpose of performing TIG welding operations.

U.S. Pat. No. 5,074,802 describes a quick disconnect connector for both electrical power and gas flow to a plasma arc torch having a plug that includes at least one pin contact and a mating receptacle that includes at least one socket contact that receives the pin contact axially. Both contacts have a central axial passage that conducts the gas flow at a sufficient rate to cool the contacts when they are conducting a large heavy operating current, typically 20 to 1,000 amperes, D.C. For a high voltage operation, each contact is closely surrounded by a barrier sleeve of a dielectric material which is supported in an insulating body filling the plug or receptacle.

U.S. Pat. No. 4,094,567 describes a quick connect-disconnect coupling for simultaneous connection and disconnection of fluid conduits and an electrical conductor. The coupling is characterized by an electrical socket structure carried by a wall across the fluid socket. The electrical socket is constructed and dimensioned for telescopic receipt of a fluid plug member adapted to be lockingly engaged in said fluid socket. The fluid plug member includes a cooperating electrical plug structure recessed within the leading end portion thereof.

### SUMMARY

One object of the present invention is to provide a connector capable of several different types of connection, while allowing for relatively easy disconnection by a user, and providing a compact design.

### BRIEF DESCRIPTION OF THE DRAWINGS

FIG. 1A is a pictorial illustration of a prior art welding gun connection to a cable.

FIG. 1B is a pictorial illustration of another prior art welding gun connection to a cable.

FIG. 2A is a side view of the pin and socket connectors according to the teachings of the present disclosure separated.

FIG. 2B is a cross-sectional side view of the mated pin and socket connectors according to the teachings of the present disclosure.

FIG. 2C is a cross-sectional side view of the mated pin and socket connectors according to the teachings of the present disclosure including the wire channel inserts.

FIG. 3A is a perspective view of the pin and socket connectors according to the teachings of the present disclosure separated.

FIG. 3B is a perspective view of the pin and socket connectors according to the teachings of the present disclosure mated.

FIG. 3C shows a cross section of the installed connection system according to the teachings of the present disclosure.

FIG. 4 is a depiction of a cable including conductive wire, feed wire and a pneumatic tube.

FIG. 5A is an illustration of an example connector constructed in accordance with the teachings of the present disclosure, including a socket connector mated with a pin connector.

FIG. 5B is a perspective view of the socket connector shown in FIG. 5A.

FIG. 5C is a perspective view of the pin connector shown in FIG. 5A.

FIG. 5D is a side view of a socket connector and a pin connector in FIG. 5A shown separated from each other.

FIG. 6 is a cross sectional view of the example connector of FIG. 5.

FIG. 7 is another cross sectional view of the example connector of FIG. 5, showing a welding wire inserted therethrough.

### DETAILED DESCRIPTION

The following description of example methods and apparatus is not intended to limit the scope of the description to the precise form or forms detailed herein. Instead the following description is intended to be illustrative so that others may follow its teachings.

The disclosed connector comprises a pair of electrical contacts that facilitate the simultaneous transfer of power, gas, and metal wire from one section of multipurpose cable to another. In general, the connector is of a pin and socket design, but the connectors are hollowed out to allow for gas and/or a metal wire feed to move through the center of the contact. The disclosed example connectors are significant because the design can be used for the multiple processes, as could be used in an exemplary multi-process welding machine by completing at least three of the required connections in a single action.

In this example, the power, wire, and the gas that surrounds the wire needs to be able to pass through a welding connector uninterrupted, but also be capable of being disconnected when swapping guns. This concern for multipurpose, simultaneous connection is resolved by the present connector by making the connections concentric through the hollow pin and socket design and having the geometry of the contacts support the transfer of the three requirements.

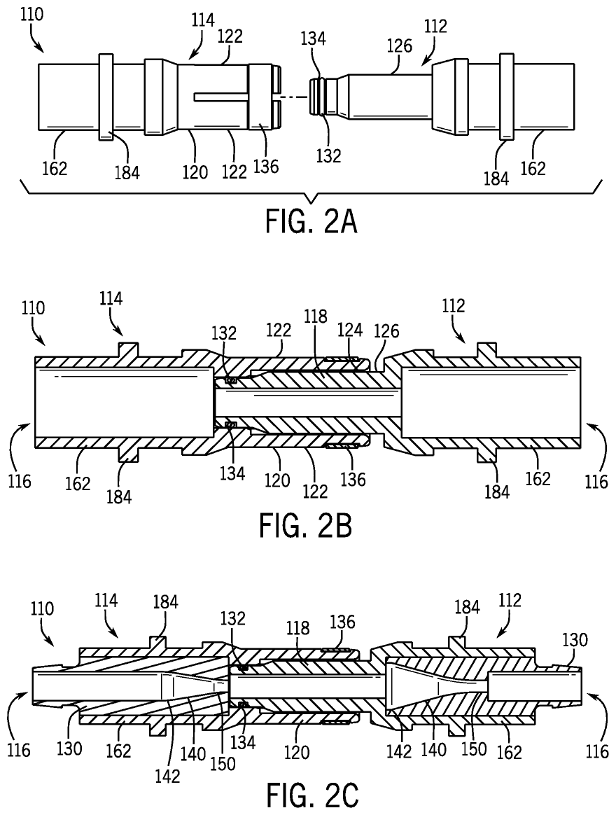

Referring now to FIG. 2A, the example connector 110 allows a user to connect, for example, both power and gas in a quick, easy-to-use, quick disconnect contact while allowing other connections like wire feeding in some examples. The disclosed connector 110 is a pin and socket design with both connector halves 112, 114 being hollow to allow for the transfer of gas and metal wire through the center.

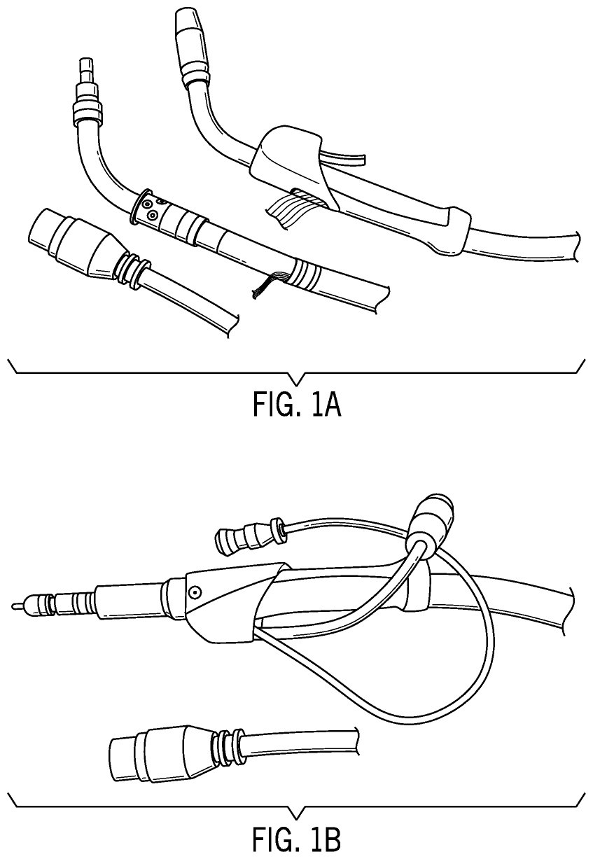

The connector halves 112, 114 are a set of power contacts with hollow cores 116 and electrical contact 118 that allow power to be transferred through a pin and socket mating style shown in FIG. 1. The connector halves 112, 114 are more commonly referred to as pin connector 112 and socket connector 114 or pin 112 and socket 114. The connector 110 takes advantage of their open inner geometry to solve issues that arise by allowing wire and gas to pass through the center of the contacts. In the example shown, each of the pin and socket connectors 112, 114 has a hollow core extending from one end of the connector to the other. The socket connector 114 and the pin connector 112 are shaped to be complementary so that a barrel end 120 of the socket connection 114 can receive a matching end of the pin connector. Thus, the mating is accomplished by at least partially inserting the pin 112 into the socket 114 that cylindrical hollow cores are aligned, simultaneously completing the electrical and pneumatic connections in one motion.

Each of the pin connector 112 and socket connector 114 include an electrical contact 118 designed to complete an electrical circuit when the pin and socket are mated. In the example shown in FIG. 2A, the pin connector 112 and socket connector 114 are each made of a conductor, such as copper or any other suitable metal. In other embodiments, only certain portions of the complementary parts of the pin and socket connectors are made from conductors as needed to conduct electricity between the contacts.

The pin and socket connectors 112, 114 are held together with an interference fit. In the example shown in FIG. 2A, the outer surface 126 of the mating end of the pin 112 has a diameter larger than a diameter of the mating end of the inner surface 124 of the barrel end 120 of the socket connector forming an interference fit when the pin connector is mated with the socket connector. One of ordinary skill in the art will understand that the interference fit will allow the connection to be made by both the natural compliance of the socket as well as flexure of the tines 122.

The diameter of the socket 114, in the example shown in FIG. 2A, is not a static dimension as the tines 122 of the socket connector 112 are typically set in, yielded, or sprung to a certain dimension during the mating with pin 114. In other examples, the dimensioning of the pin 112 and socket 114 and can be changed based on application need to adjust connection strength and ease of use. Reduced interference fit between socket and pin contacts yields a longer lifetime for less power capability

One of the connector halves should be compliant when mated to make this fit easier to couple and uncouple by hand, for example, being slotted to form tines 122, it was chosen to be the outer socket to eliminate any geometry that a metal wire could get caught on. The individual resilient fingers or tines 122a, 122b, 122c, 122d are located on one end of the socket connector 114. As shown in FIG. 2B, the tines 122 of the pin 112 expand once mated to apply pressure between the inner surface 124 of the socket 114 and the outer surface 126 of the pin 112.

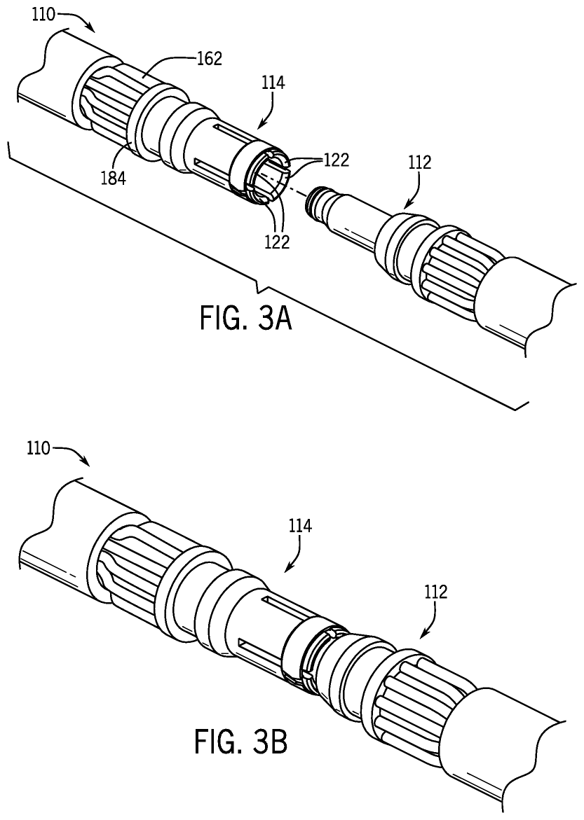

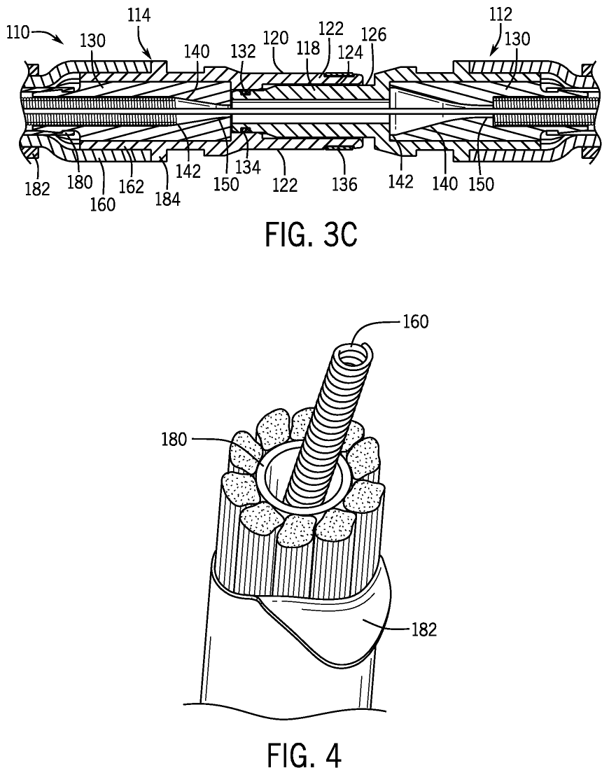

To support wire feeding through the contacts, a wire channel 140 within the cylindrical hollow core is used to control material transport within the conic geometry of the inner surface of the pin connector 112 was needed to ensure that the wire stayed centered without catching on any edges or surfaces. In some examples of the connecting system 110, this conic geometry is incorporated directly into the same continuous body forming the connectors 112, 114. In the Example shown in FIGS. 2C and 3C, an insert 130 was created with the same conic geometry for simpler manufacturing and design flexibility. FIG. 3 shows the same cross-section view from FIG. 2B but with the inserts 130 assembled into the pin and socket connectors 112, 114. The smooth transitional surface of the example wire channel 140 is formed from the continuous reduction of the diameter of the guiding slot 142 to the center hole 150. These inserts 130 contain conic centering geometry that allows for smooth transition of material feed through the connection. FIG. 4C, discussed in greater detail below, shows a feed wire 160 inserted through the feed wire channel 140. The wire 160 may also include a wire guide 146 to prevent kinking and other undesirable bending of the wire before it passes into the connection system 110.

The insert 130 is placed or at least partially inserted within the hollow core of the pin and socket connectors 112, 114. Inserts 130 allow different subassemblies of the connecting system 110 for different types of transport and adaption with different equipment such as different electrical contacts or pneumatic hoses. The insert 130 in the example shown is an injection molded thermoplastic, but could be constructive of any suitable material determined by one of ordinary skill in the art. The inserts 130 can be customized depending on the application the contacts are being used for. The example connection system 110 shown in FIG. 3 is used for welding including a wire passed through the center of connection system 110. Other example inserts 130 may be adapted for other fluid transport or loose solid being passed through.

An internal seal is placed on the pin 112 to seal off the connection area, forming an air-tight connection and prevent any or any substantial amount of material losses. In the example shown in FIG. 2C, the internal seal o-ring 132 is placed in the groove 134. In this example, o-ring 132 is on the outside of the pin 112, rather than the socket 114, as the groove 134 required is easier to fabricate when located externally. The groove 134 is located on a recessed or smaller diameter forward surface of the pin 112 that is stepped down from the larger diameter mating portion of pin 112. The groove 134 on the recessed surface prevents the O-ring 132 being scraped across the inside of the socket contact during mating and reducing the lifespan of the O-ring.

In order to enhance the contact between the pin and socket connector and secure the connection, a resilient member can be positioned on pin or socket connector 112, 114. In the example shown, the resilient member is a cylindrical spring 136 attached to the socket 114 to maintain sealing force over multiple mating cycles as can be seen in FIGS. 3A and 3B. This added pressure from spring 136 improves the quality of the electrical connection by increasing the normal force between the surfaces of each of pin or socket connector 112, 114.

Thus, the conic design of the wire channel 140 acts as a centering mechanism that directs the wire feed through the contacts and prevents the wire from catching and jamming the wire feeder. FIG. 3C displays the contact assembly assembled onto a concentric cable. For the example welding cable, the feed wire 160 is fed through a metal coil guide 146. In this example, the conic geometry of the inserts is oriented to accept the wire is fed from left to right. This geometry also doubles as a positive stop for the wire guide 146, only allowing the feed wire 160 though the center hole.

These inserts 130 also have tube fitting geometry to form an external seal between the pin and socket connectors 112, 114 on the ends to seal the gas in the transition between the cable and the contacts. Tube fitting geometry in the example connection 110 is a shaped projection 154 extending from the diameter from both outward ends of the pin and socket connections 112, 114. The projection 154 has a diameter exceeding an inner diameter of the first and second tubes to form a press fit with the resilient tube 180. The projection 154 may also include a sharp edge to grip the inside of the tube 180 as shown in the example connection 110. The inserts 140 and the sealing geometry 141 can be customized depending on the application the contacts are being used for, varying the shape and size of the projection to better secure tubes 180 of different sizes or materials as would be appreciated by one of ordinary skill in the art.

In some examples, the wire feed is supported by a liner 182 within the tube 180 as shown in FIG. 4. In this example, the liner 182 is discontinuous so that the connector can be disconnected when switching guns. The example liner is stopped from passing through the connector and a flange 184 is included on pin and socket connectors 112, 114 that the liner would fit using the central cylindrical hollow core to allow the wire feed and gas to pass from the tube 180 to the connecting system 110 through respectively. The flange 184 positioned around the outward ends of the barrels 162 which function as a mechanical stop for the tubes 180 because the flanges each have a diameter greater than the diameter of some portion of the first and second tubes. The flanges 164 locate the tube squarely and properly, leaving a portion of the conductive material exposed for the electrical connection to be completed.

An example of concentric cable or tube 180 with a liner 184 is an example welding cable, which can be seen in FIG. 4. The cable typically consists of an outer jacket, wire 160 or ring of conductor strands, an inner tube 180 for transferring gas, and a wire guide 186 to support material feed through the cable. Other cable types can be used, as would be appreciated by one of ordinary skill in the art. One other example cable would be a jacketed cable which contains discrete wires and tubing wrapped by a separate external jacket. This would simply require each part to be routed correctly during assembly.

An electrically conductive wire 190 is affixed to an external electrical connection on each of the barrels 162 which are electrically connected to the electrical contacts 116, completing an electrical connection between the first and second wires when the contacts are mated. The electrically conductive wire 190 is oriented substantially around the air bearing tube 180 in a concentric manner. In some examples, the electrically conductive wire 190 is crimped on to the barrel 162, a process that crushes the contact into the wire creating an extremely strong electrical connection. In this example shown, the stranding of the electrically conductive wire 190 from the cable is to be crimped on the outer surface of the barrel 162 at the back of each pin and socket 112, 114 using a crimp ring to wrap around the stranding and radially crush the wire into the contact.

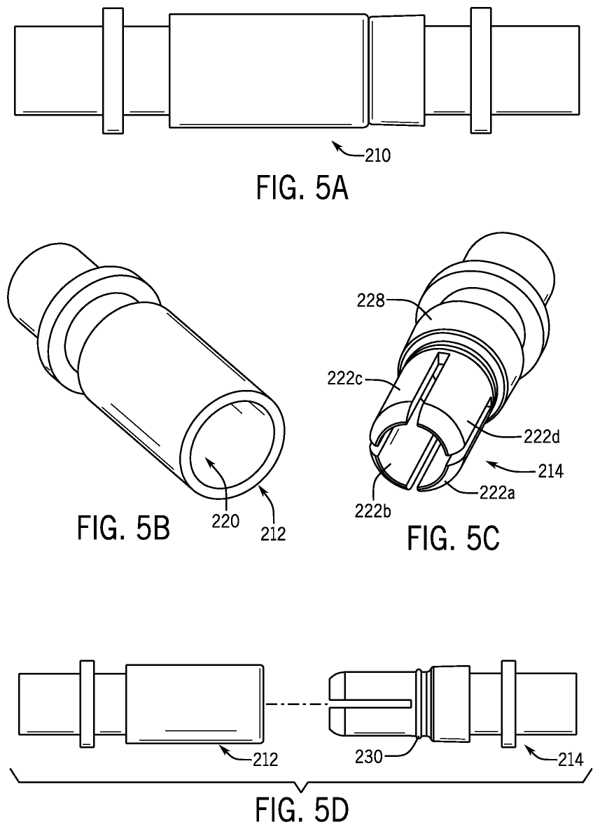

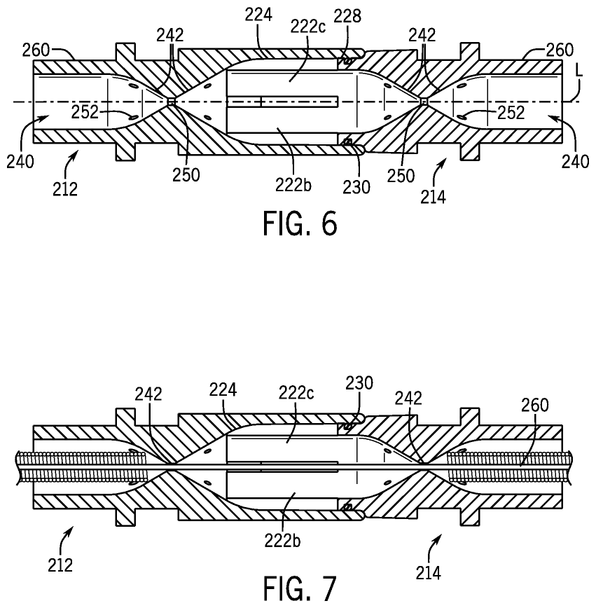

Referring now to FIGS. 5 and 6, an example of a connector 210 for a welding cable is disclosed. The example connector 210 includes two connector halves 212, 214, which in this example are generally referred to as a socket connector (212) and a pin connector (214). In this example, the two connector halves 212, 214 are each constructed of a conductive material, but it will be appreciated by one of ordinary skill in the art that at least a portion of the two connector halves 212, 214 may comprise a non-conductive material such as an outer insulation coating (not shown). Due to the conductive material, with the example connector 210, an electrical connection is made when the two connector halves 212, 214 mate as illustrated in FIG. 6.

An end of the socket connector 212 comprises a solid socket barrel 220. Correspondingly, an end of the pin connector 214 comprises a plurality of tines 222a, 222b, 222c, 222d wherein the tines 222a, 222b, 222c, 222d together are sized to provide an interference fit with an inner surface (or inner wall) 224 of the socket barrel 220. More precisely, in the illustrated example, the tines 222a, 222b, 222c, 222d of the pin connector 214 compress once mated to apply pressure on the inner surface 224 of the socket connector 212. This improves the quality of the electrical connection by increasing a normal force between the surfaces of each connector 212, 214 (e.g., the outer surfaces of each of the tines (222a-222d) and the inner surface 224). While in the current example, there are four tines illustrated, it will be appreciated that the number of tines may vary as desired.

Furthermore, in this example, the inner surface 224 of the socket connector 212 and/or an outer surface 226 of the pin connector 214 is provided with a circumferential groove 228 that, in this instance, comprises an o-ring 230, or other suitable sealing mechanism. As will be described further, as best illustrated in FIG. 6, with the o-ring 230, any gas that travels through the connector 210 is sealed within the connector 210 when the socket connector 212 and pin connector 214 mate.

Referring to FIG. 6, each of the connectors 212, 214 defines a hallowed cavity 240 extending along the length of a longitudinal axis L of each of the connectors 212, 214. A center of each of the connectors 212, 214 includes a guiding slot 242 at the center for a wire 260 (see FIG. 7) to pass through. In this illustrated example, the guiding slots 242 are each conic shaped on either side of a center hole 250 (e.g., hour-glass shaped) to act as a centering mechanism for when the wire 260 (with or without a support liner) travels through the connector 210 to thereby prevent the wire 260 from catching and/or jamming in the connector during first insertion and operation.

Returning to FIG. 6, surrounding the formed center hole 250 in each of the connectors 212, 214, and extending through the connectors between opposite sides of the guiding slots 242 are a plurality of smaller holes 252 that act as bypass paths for a gas within the connector 210. These holes 252 help keep consistent gas flow through the connector 210.

As will be appreciated, various contacts may be crimped onto barrels 262 of each connector 212, 214 using a ring to crush the wire into the connector 212, 214. Other suitable connection methods and/or devices may be utilized as desired. Further, the contacts may be designed out of any suitable electrically conductive material, such as for instance copper with a plating, to provide an electrical contact and to prevent wear and tarnish.

The proposed connecting system 110 allows a single action, multi state parallel connection within a single insulator. The system 110 is smaller and more efficient combining the power, gas and material connections into one. This also follows the design of a concentric cable and prevents the waste of materials from redirecting each part of the connection to a separate releasable connector. This system 110 thereby prevents the need for separate connections from being required for the gas and wire feed.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. An adaptable multiple purpose connector comprising:
a pin connector with a first electrical contact and a socket connector with a second electrical contact, each of the pin and socket connector having a cylindrical hollow core extending from a first end to a second end of the connector;
the first end of the pin connector shaped to be complementary to the first end of the socket connection such that the first end of the pin connector can be at least partially inserted into the first end of the socket connector such that cylindrical hollow cores are aligned and the first electrical contact is mated with the second electrical contact;
an internal seal affixed to the first end of the pin connector, wherein when the pin connector is inserted into the socket connector an air-tight seal is formed between the pin and socket connector; and
a first and second external seal positioned on the first ends of the pin and socket connectors, respectively, wherein the first and second external seal are adapted to create a pneumatic connection with a first and second tube respectively;
wherein when the pin and socket connectors are mated the cylindrical hollow cores allow a pneumatic flow between first and second tube.

2. The pneumatic electric connector of claim 1 further comprising a wire directing channel within the cylindrical hollow core.

3. The pneumatic electric connector of claim 1 further comprising at least one insert placed within the hollow core of the pin and socket connectors.

4. The pneumatic electric connector of claim 3 wherein the insert has a first end with a first inner diameter and a second end with a second inner diameter; and wherein the first inner diameter exceeds the second inner diameter.

5. The pneumatic electric connector of claim 4 further comprising a first feed wire guide comprising a smooth transitional surface between the first and second internal diameter of the pin connector.

6. The pneumatic electric connector of claim 5 further comprising a feed wire inserted through the feed wire directing channel.

7. The pneumatic electric connector of claim 6 wherein the wire directing channel is an open frustoconical shape.

8. The pneumatic electric connector of claim 3 further comprising flow apertures positioned through the insert.

9. The pneumatic electric connector of claim 3 wherein the insert is made of plastic.

10. The pneumatic electric connector of claim 1 further comprising a resilient member positioned on the first end of the socket connector to enhance the contact between the pin and socket connector.

11. The pneumatic electric connector of claim 10 wherein the first end of the pin connector has an outer diameter larger than an inner diameter of the first end of the socket connector forming a press fit when the pin connector is mated with the socket connector.

12. The pneumatic electric connector of claim 10 wherein the first end of the socket connector includes resilient fingers.

13. The pneumatic electric connector of claim 1 further comprising at least two flanges positioned around the second ends of the pin and socket connector, wherein the at least two flanges have a diameter greater than the diameter of the first and second tubes.

14. The pneumatic electric connector of claim 1 wherein
the pin connector further comprises a first external electrical connection electrically coupled to the first electrical contact, the first external electrical connection adapted to be connected to a first wire; and
the socket connector further comprises a second external electrical connection electrically coupled to the second electrical contact, the second external electrical connection adapted to be connected to a second wire,
wherein when the pin and socket connectors are mated the first and second electrical contacts complete an electrical connection between the first and second wires.

15. The pneumatic electric connector of claim 1 wherein each of the first and second external seal further comprise a projection from the second end of the pin and socket connector, wherein the projection has a diameter exceeding an inner diameter of the first and second tubes.

16. The pneumatic electric connector of claim 1 wherein the first end of the pin connector has a first section having a first diameter and a second section having a second diameter, wherein the seal is located on the first section.

17. An adaptable multiple purpose connector comprising:
a pin connector with a first electrical contact and a socket connector with a second electrical contact, each of the pin and socket connector having a cylindrical hollow core extending from a first end to a second end of the connector;
the first end of the pin connector shaped to be complementary to the first end of the socket connection such that the first end of the pin connector can be at least partially inserted into the first end of the socket connector such that cylindrical hollow cores are aligned and the first electrical contact is mated with the second electrical contact;
at least one insert placed within the hollow core of the pin and socket connectors, the insert including an open frustoconical wire directing channel with a first end having a first inner diameter and a second end having a second inner diameter, smaller than the first, wherein the wire directing channel transitions between the first and second diameter smoothly and continuously;
an internal seal affixed to the first end of the pin connector, wherein when the pin connector is inserted into the socket connector an air-tight seal is formed between the pin and socket connector; and
a first and second external seal positioned on the first ends of the pin and socket connectors, respectively, wherein the first and second external seal are adapted to create a pneumatic connection with a first and second tube respectively;
wherein when the pin and socket connectors are mated the cylindrical hollow cores allow a pneumatic flow between first and second tube.
